(19) United States
(12) Patent Application Publication
(10) Pub. No.: US 2005/0164708 A1
(43) Pub. Date: Jul. 28, 2005

(54) Dynamic adaptation of detection of requests to access a cellular communications network as a function of the radio environment associated with the requesting communications equipment

(75) Inventors: Anne Gabriel, Chatillon (FR); Pascal Agin, Chatillon (FR)

Correspondence Address: SUGHRUE MION, PLLC, 2100 PENNSYLVANIA AVENUE, N.W., SUITE 800, WASHINGTON, DC, 20037, US

(73) Assignee: EVOLIUM S.A.S.

(21) Appl. No.: 11/041,743

(22) Filed: Jan. 25, 2005

(30) Foreign Application Priority Data
Jan. 26, 2004 (FR) 04 00 770

(51) Int. Cl. H04L 12/413; H04Q 7/20

(52) U.S. Cl. 455/452.2; 455/452.1

(57) ABSTRACT

A signal processing device (D) is installed in a base station (Node B) of a cellular communications network, for example. Said device (D) comprises processing means (MT) adapted to effect preamble detection, as a function of detection parameters, on each signal sent by a requesting terminal (UE) in an authorized access slot and representative of a preamble of a request to access the network associated with an authorized signature. The processing means (MT) are adapted, on receiving a signal requesting access to the network sent by a requesting terminal (UE), to determine a value for at least one detection parameter chosen as a function of at least one selected parameter representative of the radio environment of the requesting terminal so as to adapt the detection of the received signal dynamically as a function of the radio environment of the requesting terminal (UE).

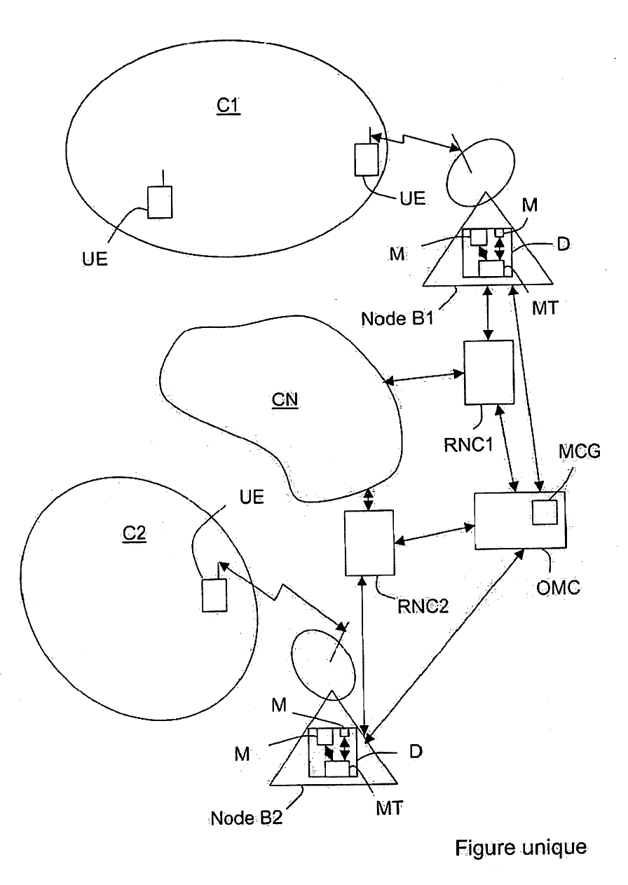

The field of the invention is that of cellular communications networks and more particularly that of detecting requests for access to cellular communications networks.

In some cellular communications networks, for example networks offering slotted ALOHA access, communications terminals may send messages only during time slots authorized by the network.

To be more precise, if a requesting terminal requires to access the network, it must send signals representative of a preamble defining an access request to its base station within said network, for example, with a view to sending an associated message.

In the case of a UMTS network, for example, the terminal uses a physical random access channel (PRACH) and an access slot of predefined width to send a preamble with a signature chosen at random from a set of authorized signatures selected by the network from U=16 signatures, for example. In a slotted ALOHA random access network, for example, the preamble has a duration of 4096 chips, the width of an access slot is 5120 chips (which corresponds to 1.3 ms), and 20 ms time slots (corresponding to two 10 ms radio frames) are periodically divided into 15 access slots

The requesting terminal may send the message associated with a preamble that has been sent to the network only if said preamble has been acknowledged by the network, to be more precise by one of its access request management units, for example a base station (Node B). The requesting terminal sends the message portion associated with the PRACH preamble when the access request management unit has detected the presence of the terminal that sent it and when the terminal has received an acknowledgement message from the unit on an acquisition indicator channel (AICH) and within a predefined acknowledgement time.

If the requesting terminal has not received an acknowledgement message in the predefined acknowledgement time, which is configurable, it sends another preamble at a higher power than the previous preamble and possibly in an access slot different from the previous access slot.

The number of preambles that may be sent consecutively and the period for sending preambles are predefined and configurable. Preambles are broadcast periodically by the network to terminals in its coverage area. Similarly, a configurable “map” of access slots in which the terminals are authorized to send preambles is broadcast periodically to the terminals in the coverage area of the network. The network also broadcasts periodically the time reference of each base station on a synchronization channel dedicated to terminals in its respective coverage area (cell).

For a base station to be able to determine that a requesting terminal is present, it effects a detection procedure for each signature authorized by the network in the cell that it manages; for each access slot in said cell authorized by the network, this procedure correlates each signal received at a preamble reception candidate time within an analysis time window of width W with complex conjugate preamble codes corresponding to the signature concerned, and then processes it, in particular squares it, in order to determine an associated correlation energy, with a view to making a decision.

For an analysis time window of width W chips and with no oversampling (oversampling factor osf=1), there are W preamble reception candidate times for a given access slot and a given signature. It is therefore possible to effect up to W correlations over the whole of the analysis time window. A first correlation is effected between the received signal and the preamble, a second correlation may be effected between the received signal and the preamble shifted by one chip, and so on; thus a W^{th} correlation may be effected between the received signal and the preamble shifted by (W−1) chips.

For an analysis time window of width W chips and with oversampling (osf>1) there are (W×osf) preamble reception candidate times for a given access slot and a given signature. It is therefore possible to effect up to (W×osf) correlations over the whole of the analysis time window. A first correlation is effected between the received signal and the preamble, a second correlation may be effected between the received signal and the preamble shifted by 1 chip/osf, a second correlation may be effected between the received signal and the preamble shifted by 2 chips/osf, and so on.

The width W of the analysis time window depends in particular on the distance between a base station and the farthest boundary of the cell that it controls. For example, an analysis time window may be chosen to have a width W of approximately 608 chips to detect a mobile terminal approximately 20 km from its base station.

As the person skilled in the art knows, the number of preambles detected erroneously by a base station depends on certain parameters of the radio channel used by a requesting terminal in its radio coverage area (cell), which in turn depend on the environment in which said requesting terminal is situated. Each base station is configured statically for the whole of its radio coverage area (cell) and therefore uses the same detection parameters for all the mobile terminals in its cell, whereas the optimum detection parameters vary as a function of the mobile terminal concerned and its radio environment. Because each detection error leads to sending a preamble at a higher power than the preceding preamble, the connection time for the requesting terminal may vary as a function of its environment. Furthermore, the level of interference within a cell may increase if terminals may behave significantly differently in its coverage area.

An object of the invention is therefore to remedy the drawback previously cited.

To this end it proposes a signal processing device, for example for a base station of a (random access) cellular communications network, said device comprising processing means adapted to effect preamble detection, as a function of detection parameters, on each signal sent by a requesting terminal in an authorized access slot and representative of a preamble of a request to access the network associated with an authorized signature.

Said processing device is characterized in that said processing means are adapted, on receiving a signal requesting access to the network sent by a requesting terminal, to determine a value for one or more detection parameters chosen as a function of at least one selected parameter representative of the radio environment of the requesting terminal so as to adapt the detection of the received signal dynamically as a function of the radio environment of the requesting terminal.

In the present context the expression “radio environment parameter” means any parameter liable to influence the radio channel used by a requesting terminal to send its access request to the network at a given time. Consequently, this parameter might be, for example, the (estimated) speed of the requesting terminal, the average speed of the mobile terminals in the cell in which the requesting terminal is situated, the Doppler effect associated with the signal sent by the requesting terminal perceived by the receiving base station, for example, the amplitude and/or phase of multiple propagation paths caused by fixed or moving obstacles, or the type of environment (home, road, motorway) in which the requesting terminal is situated.

Moreover, the processing means may comprise detection means adapted to estimate the value of each selected environment parameter. The device may instead comprise detection means coupled to the processing means and adapted to estimate the value of each selected environment parameter.

The detection means may be adapted to analyze said received signal to estimate the speed of the requesting terminal. Instead of this or in addition to this the detection means may be adapted to deduce at least one selected environment parameter from information data and/or dedicated signals sent by said requesting terminal and/or by terminals in the cell in which the requesting terminal is situated. The selected environment parameter may be the average speed of the mobile terminals in the cell in which the requesting terminal is situated.

The processing means may be adapted to effect said preamble detection for each authorized signature:
by correlating each signal received, for each of said authorized access slots, to preamble codes corresponding to each of the authorized signatures,
by then calculating, at each preamble reception candidate time, an energy associated with each processing segment whose number is at least equal to 1 and constitutes a detection parameter,
by then calculating at each candidate time the sum of said calculated segment energies,
by then determining a maximum of said energy sums within an analysis time window, and
by comparing said determined energy maximum to a selected threshold forming another detection parameter, the preamble being considered as having been detected, with the associated signature and time slot, if the corresponding determined maximum energy is above said threshold.

The steps referred to above are the main detection steps that it is necessary to understand in order to understand the invention. However, as the person skilled in the art knows, other processing steps generally complement the above main steps, for example receive filtering steps.

The number M of segments is correlated to the length L of the segments. For example, if M=1, L=4096 chips, if M=2, L=2048 chips, and if M=4, L=1024 chips, and so on.

Alternatively, the processing means may be adapted to effect their detection for each signature:
by correlating each signal received, for each of said authorized access slots, to preamble codes corresponding to each of the authorized signatures,
by calculating, at each preamble reception candidate time, an energy associated with each processing segment whose number is at least equal to 1 and constitutes a detection parameter, and
by then calculating at each candidate time the sum of the calculated segment energies and comparing that energy sum, associated with a time within an analysis time window, to a selected threshold forming another detection parameter, so as to decide that the preamble has been detected, with the associated signature and access slot, if said energy sum has a value above said threshold, within the analysis time window concerned.

Using this variant, it is not always necessary to analyze all times within the analysis time window, because the preamble is considered to have been detected and the analysis of the remainder of the window is terminated as soon as a threshold overshoot at a time within the window is detected.

In either case, the adaptable detection parameters are preferably selected from the number of segments used in calculating the energy (and the associated length) and the preamble threshold used for the comparison. The number of segments and/or the threshold are adaptable, for example.

Furthermore, the device may comprise a memory for storing a table of the correspondences between environment parameter values and detection parameter values. In this case, the processing means are adapted to determine each detection parameter value to be used by comparing each determined environment parameter value and at least one sufficiently representative set of environment parameter values stored in the correspondence table.

In one particular embodiment the memory may, for example, store a table of the correspondences between speed range values, number of segment (and associated length) values, and preamble threshold values. However, the table could merely establish the correspondence between speed range values and number of segments (and associated length) values, the threshold value being fixed in this case, or between speed range values and preamble threshold values, the number of segments (and associated length) value being fixed in this case.

The network, and in particular the radio network controller (RNC) to which the base station in which it may be installed is connected, or an Operation and Maintenance Center (OMC) of the cellular network, may send a processing device of the invention some detection parameter values that may be fed into the correspondence table and are associated with a value (or a set of values) of one or more radio environment parameters. In this case, the device may comprise configuration means for supplying the processing means with detection parameter values corresponding to different values of one or more environment parameters.

The invention also proposes, firstly, a base station for a cellular communications network equipped with at least part of a processing device of the type defined above, secondly, a controller for a cellular communications network equipped with at least part of a processing device of the type defined above, and, thirdly, an Operation and Maintenance Center (OMC) for a cellular communications network, all of the above comprising at least means for configuring a processing device of the type defined above.

The invention is particularly well suited, although not exclusively so, to the field of 3GPP terrestrial and/or satellite radio communications, and in particular to W-CDMA, CDMA 2000, IS95, UMTS and GSM/GPRS networks, and to the field of fiber optic communications.

Other features and advantages of the invention will become apparent on reading the following detailed description and examining the appended drawing, in which the single FIGURE is a diagram of one embodiment of part of a UMTS communications network comprising base stations provided with a signal processing device of the invention. In a UMTS network, a base station is known as a Node B. The appended drawing constitutes part of the description of the invention as well as, if necessary, contributing to the definition of the invention.

An object of the invention is to adapt the performance of the procedure for detecting preambles (or requests for access to a random access network) sent by communications terminals as a function of their respective radio environments.

As used hereinafter, the expression “communications terminal” means any network equipment capable of exchanging data in the form of signals, either with another equipment via their respective networks or within its own network. The communications terminals could therefore be user equipments such as fixed or portable computers, mobile telephones, personal digital assistants (PDA) or servers.

It is also considered hereinafter, by way of illustrative example, that the communications network has a slotted ALOHA access mechanism as described in the introductory portion of the description. The invention is not limited to this type of network only, however, and relates to all communications networks that communications terminals may access using a random access procedure based on sending a preamble (access request) during access slots. Thus the invention relates to random access communications networks, where applicable satellite communications networks, for example W-CDMA, CDMA 2000, IS95, UMTS and GSM/GPRS networks.

Hereinafter it is considered, by way of illustrative example, that the terminals are mobile telephone type user equipments (UE) of a 3G cellular communications network such as a UMTS network operating in frequency division duplex (FDD) or time division duplex (TDD) mode.

As shown very generally in the single FIGURE, although in sufficient detail for an understanding of the invention, a UMTS network may be regarded as a core network (CN) coupled to a radio access network (UTRAN).

The UTRAN comprises one or more Nodes B (base stations) connected to the core network CN by one or more radio network controllers RNC.

In the example shown, the UMTS network comprises two base stations, Node B1 and Node B2, connected to the core network CN via nodes RNC1 and RNC2, respectively. Also, in this example, each base station Node B1, Node B2 is associated with a single cell C1, C2 having a radio coverage area in which there may be one or more user equipments UE.

Conventionally, each Node Bi (i=1, 2) handles signal processing and in particular manages requests for access to the UMTS network by user equipments UE in the cell Ci that it controls.

In this type of random access network, as mentioned in the introductory part of the description, if a terminal UE wishes to send a message containing data, when it first accesses the network it must send an access request (preamble) to the Node B (base station) that controls the cell Ci in which it is situated. To this end, the terminal UE generates a preamble accompanied by a signature which, in the case of slotted ALOHA access, has a duration of D chips, for example D=4096 chips. The signature is chosen at random from a set of authorized signatures. In the case of a UMTS network, U=16 signatures may be used in each access slot AS, given that the total number N of access slots AS is 15. However, the number of signatures and the number of access slots AS that may be used in each cell are fixed by the network and are broadcast in each cell by the network. Consequently, a terminal considers not all 16 signatures and all 15 access slots AS, but only the signatures and access slots that the network has authorized it to consider.

The terminal UE then sends the preamble to the Node Bi in the form of a radio signal using a physical random access channel (PRACH) in one of the authorized access slots ASn.

When the Node Bi receives the signal representative of the access request (preamble), it uses an acknowledgement (or detection) mechanism to detect the presence of the requesting terminal UE in order to send it an acknowledgement message authorizing it to send the data of the message associated with the detected preamble that it previously sent.

To be more precise, to deduce the signature(s) used by each requesting terminal UE, the acknowledgement mechanism searches for all signatures in all access slots AS.

In a UMTS network, time is divided into 20 ms time slots that are in turn divided into 15 access slots AS0 to AS14. Other subdivisions may be envisaged, of course.

If all the information has been determined (i.e. if the access slot ASn and the signature s have been determined), if the signature s used is an authorized signature, and if the Node Bi is ready to receive the message associated with the detected preamble, it generates an acknowledgement AIₛ with a value of +1. If the Node Bi does not detect a signature, it generates an acknowledgement AIₛ with a value of 0. Finally, if the Node Bi detects a signature but does not wish (or is not able) to receive the associated message (for example because it has insufficient resources to process the message), it generates an acknowledgement AIₛ with a value of −1.

The Node Bi then converts the acknowledgement AIₛ associated with the signatures s that it has detected in a given access slot ASn into a series Sₛ of symbols occupying 4096 chips and constituting an acknowledgement message associated with said detected signatures. In a UMTS network each access slot has a duration of 1.3 ms, which corresponds to 5120 chips.

The Node Bi then inserts the acknowledgement message (Sₛ) into the AICH dedicated to sending acknowledgement messages during one of the N=15 access slots ASn.

Each requesting terminal UE listens to the AICH and is able to extract from it the acknowledgement message associated in particular with the signal that it used to send its preamble (access request) and to deduce from that message if the acknowledgement is effective or not.

As mentioned in the introduction, the terminal UE is able to send the message associated with the preamble it sent previously only if it receives the acknowledgement message during the acknowledgement time for which it is configured. If there is an acknowledgement message but the terminal UE receives the message outside the acknowledgement time, it is not able to send the message associated with the preamble previously sent because, in the meantime, it has sent its preamble again using a new signature drawn at random, a new access slot, and a power higher than that used to send the preceding preamble, or otherwise has aborted the procedure. Similarly, if there is no acknowledgement message, the terminal UE sends it preamble again using a new signature drawn at random, a new access slot and a power higher than that used to send the preceding preamble.

The preamble acknowledgement mechanism (PRACH procedure) described in outline above is defined in detail in 3GPP Technical Specifications TS 25.211, TS 25.213 and TS 25.214.

It is clear from the foregoing description that the acknowledgement mechanism is very important, in particular in terms of the network access time for the requesting terminals UE and the level of interference. There are situations in which the acknowledgement mechanism, also referred to as the detection procedure, does not proceed correctly. These situations are referred to as false alarm situations and non-detection situations and arise with a false alarm probability P_{fa} and a non-detection probability P_{nd}, respectively, that must be as low as possible, regardless of the radio environments of the requesting terminals, if effective detection of the PRACH preamble is to be achieved.

The invention is therefore aimed at adapting detection parameters dynamically as a function of the radio environments of the requesting terminals UE, which improves detection performance compared to situations in which the detection parameters are fixed.

The expression “radio environment” refers to any parameter liable to disturb (or influence) directly or indirectly the radio channel used by a requesting terminal UE to send its access request to the network at a given time, for example the (estimated) speed of the requesting terminal UE relative to its Node Bi, the Doppler effect associated with the signal sent by the requesting terminal UE if it is moving relative to its Node Bi or if the environment of the requesting terminal UE is moving (for example onboard a vehicle), the amplitude and/or phase of multiple propagation paths induced by fixed obstacles (such as buildings) or moving obstacles (such as persons or vehicles), or the type of environment in which the requesting terminal UE is situated (town, regional or national road, motorway, etc.).

The influence of the radio environment on the false alarm probability P_{fa} and the non-detection probability P_{nd} (which is equal to 1−P_{d}, where P_{d} is the probability of detection of the preamble) is described hereinafter; these probabilities are used to assess the performance of PRACH preamble detection.

Two false alarm probabilities may be identified. A first false alarm probability P₁ relates to the probability of detecting a signature different from the signature that was sent. The second false alarm probability P₂ relates to the probability of detecting at least one of the 16 signatures even though no preamble has been sent. The two probabilities P₁ and P₂ are linked by the equation P₂=1−(1−P₁)¹⁶, and for this reason only the first probability P1 is considered hereinafter.

The probability of obtaining a false alarm in the theoretical situation of a channel AWGN, an analysis time window of width W equal to 1 chip, a Node B comprising a number Nᵣₓ of receive antennas equal to 2 (j=1 or 2), and a correlation over M segments (M=1, 2, 4, 8, etc.) of length L/M (where L=4096 chips), is the conditional probability that the sum of the energy calculated over the M segments is above the preamble threshold PT, given that no preamble has been sent. It can be shown that this false alarm probability P_{fa} is given by the following equation:

$${P}_{fa} = {P}_{fa} ( W = 1 , {N}_{rx} = 2 , M )$$

$${P}_{fa} = Proba ( \frac{1}{M} {\sum }_{i = 0}^{M - 1} ( {\vert {C}_{i}^{( 1 )} \vert}^{2} + {\vert {C}_{i}^{( 2 )} \vert}^{2} ) \geq PT * {σ}^{2} \text{\vert} no preamble sent )$$

which may be rewritten:
   P_{fa}=Proba(E≧PT*σ²|no preamblesent)
in which E is the correlation energy, σ² is the variance of thermal noise (also denoted N₀), and Cᵢ^{(j)} is the correlation amplitude of length L/M, calculated over the segment number i (i=0, 1, . . . , M−1) and for receive antenna number j (here j=1 or 2), which may be calculated from the following equation:

$${C}_{i}^{( j )} = \frac{M}{L} * {\sum }_{k = i * \frac{L}{M}}^{( ( i + 1 ) * \frac{L}{M} ) - 1} {r}_{i}^{( j )} * {\overline{C}}_{i}$$
in which L is the length in chips of the preamble (here L=4096), rᵢ^{(j)} is the signal received by the receive antenna j, and \overline{Cᵢ} is the conjugate of the complex number Cᵢ that is multiplied by the received signal rᵢ^{(j)}; Cᵢ is equal to the product of the binary preamble PRACH and the scrambling code used to send the PRACH preamble and another complex number of modulus equal to 1. It is important to note that, because no preamble has been sent, the signal received by each antenna of the receiving Node B consists entirely of thermal noise.

It can be shown that, under the conditions cited above, the false alarm probability P_{fa} may then be reformulated as follows:

$${P}_{fa} = {P}_{fa} ( W = 1 , {N}_{rx} = 2 , M ) = exp ( - PT * L ) * {\sum }_{k = 0}^{2 M - 1} \frac{1}{k !} {( - PT * L )}^{k}$$

It can also be shown that in the case of any number of receive antennas Nᵣₓ, but in all cases with an analysis time window of width w equal to 1 chip, the above equation may be written as follows:

$${P}_{fa} = {P}_{fa} ( W = 1 , {N}_{rx} , M ) = exp ( - PT * L ) * {\sum }_{k = 0}^{{N}_{rx} * M - 1} \frac{1}{k !} {( - PT * L )}^{k}$$

Finally, this latter equation may be generalized to the situation of an analysis time window of any width W, by writing:
P_{fa}=P_{fa}(W, Nᵣₓ, M)
P_{fa}=Proba(∃jε[0; W−1]/Corr(j)²≧σ²*PT|no preamblesent)
which may be rewritten:
   P_{fa}=1−Proba(∀jε[0; W−1]/Corr(j)²<σ²* PT|no preamblesent)
which may in turn be rewritten:
   P_{fa}=1−(1−P_{fa}(W=1,Nᵣₓ,M))^{W}

It emerges from the above equations that the false alarm probability P_{fa} varies essentially as a function of the value (in decibels (dB)) of the preamble threshold PT and the number M of segments used. To be more precise, the false alarm probability P_{fa} is directly proportional to the number of segments (M=1) and inversely proportional to the preamble threshold PT chosen.

Moreover, it can be shown that for a fixed false alarm probability P_{fa} the optimum preamble threshold PT depends in particular on the number M of segments chosen (in fact it depends on P_{fa}, M and W). Now, as will emerge hereinafter, for a fixed false alarm probability P_{fa} the optimum number M of segments depends at least on the environment parameter consisting of the speed of the requesting terminal UE. Consequently, the optimum preamble threshold PT also depends at least on the environment parameter consisting of the speed of the requesting terminal UE.

As a result, in a disturbed radio environment, the performance of the detection procedure is proportional to the preamble threshold PT.

The preamble detection probability P_{d} and the preamble non-detection probability P_{nd} are discussed next.

The detection probability P_{d} is the probability of a signature sent with a preamble being detected correctly. The non-detection probability P_{nd} is the probability of a signature sent with a preamble not being detected. These two probabilities are linked by the equation P_{nd}=1−P_{d}. The probability of detecting a in preamble in the theoretical situation of an AWGN channel, an analysis time window of width W equal to 1 chip, a Node B comprising a number Nᵣₓ of receive antennas equal to 2 (j=1 or 2), and a correlation over M segments (M=1, 2, 4, 8, etc.) of length L/M (with L=4096 chips), is the conditional probability of the energy sum calculated over the M segments being above the preamble threshold PT, given that a preamble has been sent. It can be shown that the detection probability P_{d} is given by the following equation:

$${P}_{d} = {P}_{d} ( W = 1 , {N}_{rx} = 2 , M )$$

$${P}_{d} = Proba ( \frac{1}{M} {\sum }_{i = 0}^{M - 1} ( {\vert {C}_{i}^{( 1 )} \vert}^{2} + {\vert {C}_{i}^{( 2 )} \vert}^{2} ) \geq PT * {σ}^{2} \vert a preamble has been sent )$$

This equation contains the same variables Cᵢ^{(j)} as the previous equations, but this time the signal received by each antenna of the receiving Node B is equal to the sum of the signal sent and thermal noise.

It can be shown that, under the conditions previously cited, the detection probability P_{d} may then be reformulated as follows:

$${P}_{d} = {P}_{d} ( W = 1 , {N}_{rx} = 2 , M ) = {Q}_{2 M} ( 2 * \sqrt{\frac{{E}_{C}}{{σ}^{2}} * L} , \sqrt{2 * PT * L} )$$

where Qₘ(a,b) is the generalized Marcum function and E_{c} is the energy per chip of the signal received by the Node B.

It can also be shown that in the theoretical situation of an AWGN channel and any number of receive antennas Nᵣₓ, and regardless of the width of the analysis time window, the last equation may be replaced by the following approximate equation, which is valid only if the false alarm probability P_{fa} over (W−1) chips is negligible compared to the detection probability over 1 chip:

$${P}_{d} = {P}_{d} ( {N}_{rx} , M ) = {Q}_{{N}_{rx} M} ( \sqrt{\frac{{E}_{C}}{{σ}^{2}} * 2 * {N}_{rx} * L} , \sqrt{2 * PT * L} )$$

Remember that the non-detection probability P_{nd} may be deduced from the detection probability P_{d} using the equation P_{nd}=1−P_{d}.

It is important to note that the detection probability P_{d} in the theoretical situation of an AWGN channel is not very dependent on the width W of the analysis time window for a low false alarm probability P_{fa} because, if no preamble is detected in the first chip, then it is not possible to improve the detection probability by increasing the width W of the analysis time window, and the non-detection probability is consequently the same regardless of W. In a realistic environment, for example in the situation of a terminal UE in a vehicle, the approximate equation referred to above (which is valid in the situation of an AWGN channel) is no longer valid. There is then no simple equation linking W and P_{fd}. Nevertheless, digital simulations have shown that the detection probability P_{d} is no longer independent of the width W of the analysis time window.

It emerges from the above equations and from digital simulations that the non-detection probability P_{nd} varies as a function of the value of the ratio E_{c}/σ² (or E_{c}/N₀), the width W of the analysis time window, the number M of segments used, and at least one parameter disturbing (or influencing) the radio environment of the requesting terminal UE, for example the speed of the mobile. It may in particular be observed that the non-detection probability P_{nd} is inversely proportional to the ratio E_{c}/σ² (or E_{c}/N₀) and directly proportional to the number of segments (M=1).

In digital simulations the ratio E_{c}/σ² represents the mean energy that the Node B must receive to achieve a given quality (for example a P_{nd} of 1%) when the effects of rapid variations of the radio channel induced by the environment parameters are averaged. It may in particular be observed that the variations are inversely proportional to the ratio E_{c}/σ². Consequently, in a disturbed radio environment, the performance of the detection procedure is directly proportional to the ratio E_{c}/σ². It may also be noted for a P_{nd} of 1% the value (in dB) of E_{c}/σ² varies as a function of the number M of segments and the speed of the requesting terminal UE, in the following manner (these values are given by way of non-limiting example):

| Speed of UE | | | | |
|---|---|---|---|---|
| (kilometers per | | | | |
| hour (kph)) | M = 1 | M = 2 | M = 4 | M = 8 |
| 3 | −18.4 | −17.7 | −16.8 | −15.7 |
| 50 | −18.2 | −17.6 | −16.8 | −15.8 |
| 120 | −17.8 | −17.9 | −17.1 | −16.2 |
| 250 | −16.7 | −18.3 | −17.9 | −17.2 |
| 400 | −14.6 | −17.8 | −18.0 | −17.5 |

For example, if the environment parameter that is disturbing the radio channel PRACH is the speed of the requesting terminal UE:
if the correlation is effected over only one segment (M=1), detection performance is seriously degraded for speeds from about 250 kph to about 400 kph, compared to lower speeds,
compared to the situation where M=1, if the correlation is effected over two segments (M=2), detection performance is slightly degraded for speeds less than about 200 kph and there is no significant deterioration of performance for speeds from about 250 kph to about 400 kph, and
compared to the situation where M=1, if the correlation is effected over more than two segments (M=4 or 8), detection performance is seriously degraded for speeds of less than about 200 kph, slightly degraded for speeds from about 250 kph to about 400 kph, and not significantly degraded for speeds exceeding about 450 kph.

In other words:
M=1 is a good compromise for speeds from about 0 kph to about 110 kph,
M=2 is a good compromise for speeds from about 110 kph to about 350 kph,
M=4 is a good compromise for speeds from about 350 kph to abut 500 kph, and
M=8 is a good compromise for speeds greater than about 500 kph.

In other words, and as previously mentioned, the optimum number M of segments varies at least as a function of P_{nd} and the environment parameter consisting of the speed of the requesting terminal UE. Furthermore, it can be shown that to each number M of segments there corresponds a preamble threshold PT value that is the optimum for a fixed overall false alarm probability, as calculated over the 16 possible signatures.

To enable adaptation of the detection parameters as a function of the radio environment, the invention proposes to equip each base station (Node Bi) of the network with a device D for processing signals representative of access requests (preambles) in particular.

It is important to note that a device of the invention may be installed, at least in part, in a network equipment other than a base station, and in particular in a radio network controller (RNC).

A processing device D of the above kind implements the acknowledgement mechanism (detection process) described above in a dynamically adaptable form.

To be more precise, the processing device D of the invention includes a processing module MT connected to the module receiving signals from the Node Bi in which it is installed (or to which it is coupled).

When it receives a network access request signal sent by a requesting terminal, the processing module MT determines a value for at least one detection parameter chosen as a function of the value of at least one selected parameter representative of the radio environment of the requesting terminal.

The value of each radio environment parameter may be determined either on receiving the access request signal, where applicable by analyzing it, or before it is received. To this end, the processing module MT may either include an environment parameter detection module or co-operate with a detection module MD belonging to the device D, as shown here.

For example, the detection module MD may analyze the signal received to estimate the speed of the requesting terminal UE relative to its Node Bi. Any technique known to the person skilled in the art may be used for this purpose, including indirect techniques based on determining another environment parameter beforehand, for example the Doppler effect associated with the radio channel. Of course, other environment parameters may be determined from the received signal, for example the amplitude and/or the phase of multiple propagation paths or the type of environment in which the requesting terminal UE is situated.

Instead of or in addition to this, the detection module MD may deduce the value of at least one chosen environment parameter from information data, for example local measurements, and/or dedicated signals, sent by the requesting terminal UE and/or by terminals in the cell in which the requesting terminal UE is situated. For example, the information data and dedicated signals that may be used include pilot bits of the DPCCH of one or more mobile terminals or other DPCCH or DPDCH bits. For example, the environment parameter selected may be the average speed of the mobile terminals in the cell in which the requesting terminal UE is situated, the average number of multiple propagation paths in the cell, or an average variation of the radio channel, for example the variance.

It is important to note that the detection module MD may be adapted to determine the values of a plurality of environment parameters of different types before and/or after an access request signal is received. Moreover, the detection module MD may be used in other situations. Thus is may be shared with other entities of the Node B in which it is installed, for example to adapt channel estimation as a function of speed.

With the value(s) of the environment parameter(s) determined (or estimated), whether before or after an access request signal is received, the processing module MT determines the value that at least one of the detection parameters must take, allowing for each environment parameter value that has been determined. In other words, the processing module MT dynamically adapts the value of one or more selected detection parameters as a function of each environment parameter value determined from the signal sent by the requesting terminal UE. The number of detection parameters that may be adapted depends on the configuration of the device D, to be more precise on the level of constant performance looked for.

In the present context the expression “detection parameter” means any parameter operative in estimating the false alarm probability P_{fa} and/or the non-detection probability P_{nd}, for example the number M of segments (and the associated segment length L) or the preamble threshold PT.

For example, the processing module MT is adapted to adapt the number M of segments and/or the preamble threshold PT.

Two ways of determining environment parameter values to be used may be envisaged.

One way is to calculate the values directly from equations derived from false alarm probability P_{fa} equations and/or non-detection probability P_{nd} equations, such as those described above or equivalent equations.

A second way is to determine the values in a table of correspondences stored in a memory M of the device D. To be more precise, the memory M may store a table of the correspondences between environment parameter values and detection parameter values.

For example, the table establishes a correspondence between speed ranges, numbers M of segments (and the associated correlation length L of each segment), and preamble thresholds PT, as in the following example.

| Estimated | | Correlation | |
|---|---|---|---|
| speed | Number M of | length L | Preamble |
| (kph) | Segments | (chips) | threshold (dB) |
| 0-109 | 1 | 4096 | −23.3 |
| 110-349 | 2 | 2048 | −22.3 |
| 350-499 | 4 | 1024 | −21.1 |
| ≧500 | 8 | 512 | −19.5 |

The above table provides four sets of three detection parameters adapted to four different radio environments caused by the different speeds at which the requesting terminals UE are moving.

In this example, the processing module MT is therefore configured to determine the estimated speed of the requesting terminal UE, in co-operation with the detection module MD, and then to determine in the table of correspondences the values of the number M of segments, the correlation length L and the preamble threshold PT that are stored in corresponding relationship to the speed range in which the estimated speed value falls.

Of course, the table could establish only a correspondence between speed ranges and numbers M of segments (and associated lengths L), in which case the preamble threshold PT value is fixed, or between speed ranges and preamble threshold PT values, in which case the value of the number M of segments (and the associated length L) is fixed.

Moreover, only a sufficiently representative set of parameter values is looked up in the table. In this case, the value or each value stored in the table in corresponding relationship to the “tabulated” value that is closest to the estimated value there is extracted from the table.

Moreover, some detection parameter values that may be put into the correspondence table and associated with a value (or a set of values) of at least one radio environment parameter may be sent to the processing device D via the cellular network and preferably via the radio network controller RNC to which the Node B in which it is installed is connected.

According to the current version of the UMTS standard, each RNC fixes the detection threshold that is used by each Node B that it controls. The NBAP is the protocol used to send the detection threshold information to the Node B using a “common transport channel setup” message. Consequently, adaptation of the UMTS standard may be envisaged so that an RNC can send a plurality of detection parameter values, for example the detection threshold or the number M of segments, corresponding to different values of at least one parameter characteristic of the radio environment to the processing device D of a Node B that it controls, using the NBAP and where applicable the message previously cited.

The processing device D may include a configuration module MCG for supplying detection parameter values associated with radio environment parameter values to a processing module MT installed in a Node B. The configuration module MCG may be installed in a local LMT terminal that is connected directly to the Node B concerned to supply it with parameter values.

The configuration module MCG may instead be installed in an Operation and Maintenance Center (OMC) of the cellular network. The OMC manages the Nodes B and the RNCs of the GSM network separately. In particular, it controls Node B operation and maintenance either directly, in terms of physical operation and maintenance, or indirectly via their respective RNCs, in respect of logical operation and maintenance. When equipped with a configuration module MCG, the OMC can therefore send values adapted to their respective requirements to selected Nodes B (and where applicable to selected RNCs).

Once the processing module MT has the adaptable detection parameters needed for detecting the preamble, the processing module MT has only to effect said detection.

To this end, it starts by correlating the signal received to preamble codes that correspond to each of the authorized signals within said cell for each of the N access slots ASn authorized within the cell that it manages. The processing module MT then calculates, at each preamble reception candidate time, the energy (of the correlation) associated with each processing segment from the segments whose number M may where applicable be determined from environment parameter(s) that have been determined, in the case of an adaptable detection parameter. It then calculates the sum of the energies of the M segments for each candidate time and then determines the maximum energy sum calculated within an analysis time window. The processing module MT then compares the maximum energy determined to the preamble threshold PT, which may where applicable be determined from the environment parameter(s) that have been determined, in the case of an adaptable detection parameter. This determines the exact time within the analysis time window of width W at which the preamble is received. Finally, the processing module MT decides to acknowledge the preamble (i.e. to consider it as detected), with the associated signature s and access slot ASn, if and only if the corresponding maximum energy that has been determined is above the preamble threshold PT.

Alternatively, the processing module MT starts by correlating the received signal to preamble codes that correspond to each of the U authorized signatures for each of the N authorized access slots ASn. The processing module MT then calculates, at each preamble reception candidate time, the energy (of the correlation) associated with each processing segment from the segments whose number M may where applicable be determined from environment parameter(s) that have been determined, in the case of an adaptable detection parameter. It then calculates for each candidate time the sum of the energies of the M segments and compares the result to the preamble threshold PT, which may where applicable be determined from environment parameter(s) that have been determined, in the case of an adaptable detection parameter. If the energy sum associated with a time in the analysis time window is below the threshold PT, then it compares the energy sum associated with the next time to the threshold PT. On the other hand, as soon as an energy sum if above the threshold PT, it decides to acknowledge the preamble (i.e. to consider it detected), together with the associated signature s and access slot ASn. Consequently, as soon as a detection result is positive within an analysis time window it is no longer necessary to compare the associated energy sums at subsequent times within the time window concerned.

The processing device D of the invention, and in particular its processing module MT, detection module MD, configuration module MCG and, where applicable, memory M, may take the form of electronic circuits, software (or data processing) modules, or a combination of circuits and software.

The invention is not limited to the embodiments of a processing device and a base station described above by way of example only, but encompasses all variants that the person skilled in the art might envisage that fall within the scope of the following claims.

1. A signal processing device (D) for a cellular communications network, said device (D) comprising processing means (MT) adapted to effect preamble detection, as a function of detection parameters, on each signal sent by a requesting terminal (UE) in an authorized access slot and representative of a preamble of a request to access said network associated with an authorized signature, which device is characterized in that said processing means (MT) are adapted, on receiving a signal requesting access to the network sent by a requesting terminal (UE), to determine a value for at least one detection parameter chosen as a function of at least one selected parameter representative of the radio environment of said requesting terminal so as to adapt the detection of said received signal dynamically as a function of the radio environment of said requesting terminal (UE).

2. A device according to claim 1, characterized in that said environment parameter is selected from a group comprising the estimated speed of the requesting terminal (UE), an average speed of mobile terminals in the cell in which said requesting terminal (UE) is situated, a Doppler effect associated with the signal sent by the requesting terminal (UE), a multipath amplitude, a multipath phase, and the type of environment in a cell (C) managed by a base station (Node B) of said network.

3. A device according to claim 1, characterized in that said processing means (MT) comprise detection means (MD) adapted to estimate the value of each selected environment parameter.

4. A device according to claim 1, characterized in that it comprises detection means (MD) coupled to said processing means (MT) and adapted to estimate the value of each selected environment parameter.

5. A device according to claim 1, characterized in that it comprises detection means (MD) coupled to said processing means (MT) and adapted to estimate the value of each selected environment parameter, and in that said detection means (MD) are adapted to analyze said received signal to estimate the speed of the requesting terminal (UE).

6. A device according to claim 1, characterized in that it comprises detection means (MD) coupled to said processing means (MT) and adapted to estimate the value of each selected environment parameter, and in that said detection means (MD) are adapted to deduce at least one selected environment parameter from information data and/or dedicated signals sent by said requesting terminal (UE).

7. A device according to claim 1, characterized in that it comprises detection means (MD) coupled to said processing means (MT) and adapted to estimate the value of each selected environment parameter, and in that said detection means (MD) are adapted to deduce at least one selected environment parameter from information data and/or dedicated signals sent by terminals in the cell in which said requesting terminal (UE) is situated.

8. A device according to claim 7, characterized in that said selected environment parameter is the average speed of the mobile terminals in the cell in which said requesting terminal (UE) is situated.

9. A device according to claim 1, characterized in that said processing means (MT) are adapted to effect said preamble detection for each signature: i) by correlating each signal received, for each of said authorized access slots, to preamble codes corresponding to each of the authorized signatures, ii) by calculating, at each preamble reception candidate time, an energy associated with each processing segment whose number is at least equal to 1 and constitutes a detection parameter, and iii) by then calculating at each candidate time the sum of said calculated segment energies and comparing that energy sum, associated with a time within an analysis time window, to a selected threshold forming another detection parameter, so as to decide that the received preamble has been detected, with the associated signature and access slot, if said energy sum has a value above said threshold, within said analysis time window concerned.

10. A device according to claim 1, characterized in that said processing means (MT) are adapted to effect said preamble detection for each signature: i) by correlating each signal received, for each of said authorized access slots, to preamble codes corresponding to each of the authorized signatures, ii) by calculating, at each preamble reception candidate time, an energy associated with each processing segment whose number is at least equal to 1 and constitutes a detection parameter, iii) by then calculating at each candidate time the sum of said calculated segment energies, iv) by then determining a maximum of said energy sums within an analysis time window, and v) by comparing said determined energy maximum to a selected threshold forming another detection parameter, the preamble being considered as having been detected, with the associated signature and time slot, if said corresponding determined maximum energy is above said threshold.

11. A device according to claim 9, characterized in that said number of segments and/or said threshold are adaptable.

12. A device according to claim 10, characterized in that said number of segments and/or said threshold are adaptable.

13. A device according to claim 1, characterized in that it comprises a memory (M) in which is stored a table of the correspondences between environment parameter values and detection parameter values and in that said processing means (MT) are adapted to determine each detection parameter value to be used by comparing each determined environment parameter value and at least one selected set of environment parameter values stored in said correspondence table.

14. A device according to claim 13, characterized in that said memory (M) stores a table of the correspondences between speed range values, number of segment values, and threshold values.

15. A device according to claim 13, characterized in that said memory (M) is adapted to be supplied with environment parameter values and associated detection parameter values by a controller (RNC) of said network.

16. A device according to claim 1, characterized in that said processing means (MT) are adapted to receive from a controller (RNC) of said network detection parameter values corresponding to a plurality of values of at least one environment parameter.

17. A device according to claim 1, characterized in that it comprises configuration means (MCG) adapted to supply to said processing means (MT) detection parameter values corresponding to different values of at least one environment parameter.

18. A base station (Node B) for a cellular communications network, characterized in that it comprises at least part of a processing device (D) according to claim 1.

19. A controller (RNC) for a cellular communications network, characterized in that it comprises at least a part of a processing device (D) according to claim 1.

20. An operation and maintenance center (OMC) for a cellular communications network, characterized in that it comprises means (MCG) for configuring a processing device (D) according to claim 1.
